(19) United States
(12) Patent Application Publication
(10) Pub. No.: US 2025/0240376 A1
(43) Pub. Date: Jul. 24, 2025

(54) IMAGE FORMING APPARATUS CAPABLE OF SUPPRESSING DETERIORATION OF ADJUSTMENT SHEET USED IN ADJUSTMENT OF IMAGE READING PORTION, AND ADJUSTMENT METHOD

(71) Applicant: KYOCERA Document Solutions Inc., Osaka (JP)

(72) Inventors: Shin Ishikawa, Osaka (JP); Shinji Nakatsuka, Osaka (JP)

(21) Appl. No.: 19/033,410

(22) Filed: Jan. 21, 2025

(30) Foreign Application Priority Data
Jan. 23, 2024 (JP) 2024-007912

(51) Int. Cl. H04N 1/00; B41J 2/165; B41J 11/00

(52) U.S. Cl. CPC H04N 1/00782; B41J 2/16505; B41J 11/0022; H04N 1/00588

(57) ABSTRACT

An image forming apparatus includes an image forming portion, a heating portion, a conveyance processing portion, a reading processing portion, and an adjustment processing portion. The image forming portion forms an ink image on a sheet. The heating portion heats the sheet on which the ink image has been formed. The conveyance processing portion executes conveyance processing for conveying an adjustment sheet without forming the ink image in a state where drive of the heating portion is stopped. The reading processing portion reads an image on the adjustment sheet conveyed by the conveyance processing. The adjustment processing portion adjusts an image reading portion based on a result of the reading by the reading processing portion.

### INCORPORATION BY REFERENCE

This application is based upon and claims the benefit of priority from the corresponding Japanese Patent Application No. 2024-007912 filed on Jan. 23, 2024, the entire contents of which are incorporated herein by reference.

### BACKGROUND

The present disclosure relates to an image forming apparatus and an adjustment method.

There is known an image forming apparatus including an image forming portion which forms an image on a sheet conveyed along a predetermined conveying path, a heating portion which heats the sheet on which the image has been formed by the image forming portion on the conveying path, and an image reading portion which reads the image formed on the sheet by the image forming portion on the conveying path.

### SUMMARY

An image forming apparatus according to an aspect of the present disclosure includes an image forming portion, a heating portion, an image reading portion, a conveyance processing portion, a reading processing portion, and an adjustment processing portion. The image forming portion forms an ink image on a sheet conveyed along a predetermined conveying path. The heating portion heats the sheet on which the ink image has been formed by the image forming portion on the conveying path. The image reading portion reads the ink image formed on the sheet by the image forming portion on the conveying path. The conveyance processing portion executes conveyance processing for conveying an adjustment sheet on which a predetermined adjustment image has been formed in advance without forming the ink image along the conveying path in a state where drive of the heating portion is stopped. The reading processing portion reads the adjustment image on the adjustment sheet conveyed by the conveyance processing using the image reading portion. The adjustment processing portion adjusts the image reading portion based on a result of the reading by the reading processing portion.

An adjustment method according to another aspect of the present disclosure is executed in an image forming apparatus including an image forming portion which forms an ink image on a sheet conveyed along a predetermined conveying path, a heating portion which heats the sheet on which the ink image has been formed by the image forming portion on the conveying path, and an image reading portion which reads the ink image formed on the sheet by the image forming portion on the conveying path, and includes a conveyance step, a reading step, and an adjustment step. The conveyance step includes executing conveyance processing for conveying an adjustment sheet on which a predetermined adjustment image has been formed in advance without forming the ink image along the conveying path in a state where drive of the heating portion is stopped. The reading step includes reading the adjustment image on the adjustment sheet conveyed by the conveyance processing using the image reading portion. The adjustment step includes adjusting the image reading portion based on a result of the reading in the reading step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a system configuration of an image forming apparatus according to an embodiment of the present disclosure;

FIG. 2 is a cross-sectional view showing a configuration of the image forming apparatus according to the embodiment of the present disclosure;

FIG. 3 is a plan view showing a configuration of an image forming portion of the image forming apparatus according to the embodiment of the present disclosure; and

FIG. 4 is a flowchart showing an example of adjustment processing executed by the image forming apparatus according to the embodiment of the present disclosure.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### [Configuration of Image Forming Apparatus 100]

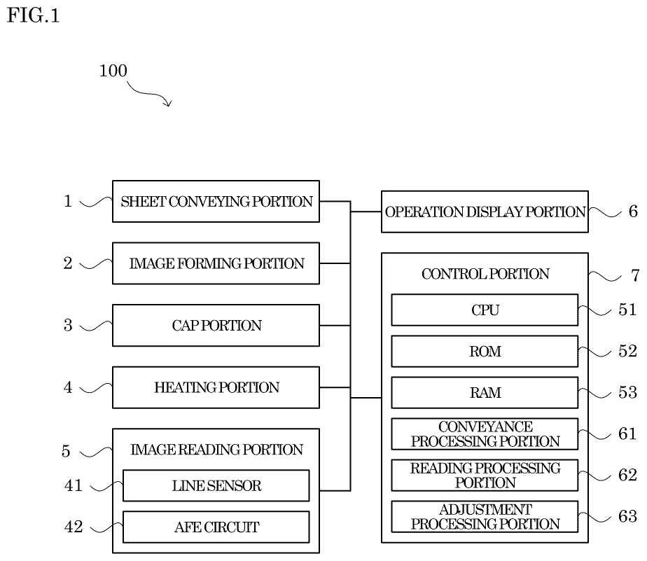

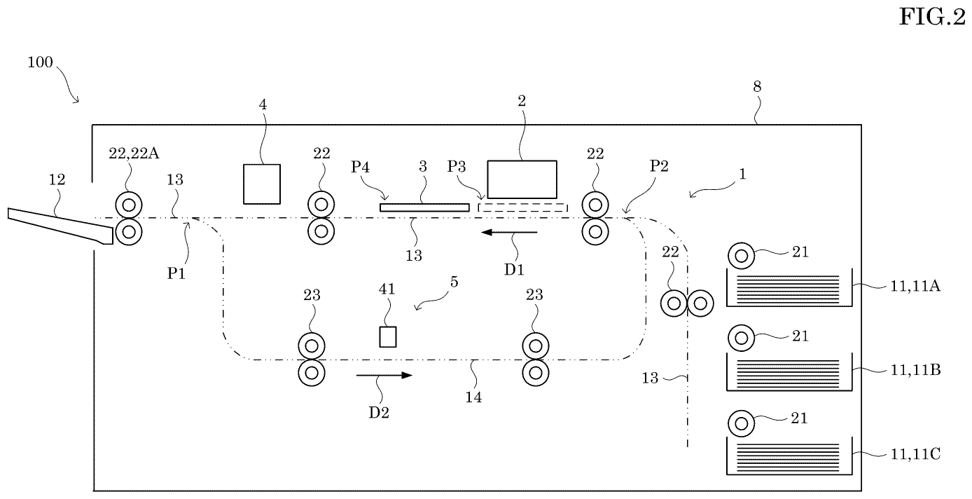

First, a configuration of an image forming apparatus 100 according to the embodiment of the present disclosure will be described with reference to FIG. 1 to FIG. 3. It is noted that in FIG. 2, a first sheet conveying path 13 and a second sheet conveying path 14 are indicated by dash-dot-dot lines. Also in FIG. 2, a cap portion 3 arranged at a cap position P3 is indicated by a broken line.

The image forming apparatus 100 is a printer that is capable of forming an image on a sheet using an inkjet system. It is noted that the present disclosure may also be applied to image forming apparatuses such as a facsimile apparatus, a copying machine, and a multifunction peripheral that are capable of forming an image on a sheet using the inkjet system.

As shown in FIG. 1 and FIG. 2, the image forming apparatus 100 includes a sheet conveying portion 1, an image forming portion 2, the cap portion 3, a heating portion 4, an image reading portion 5, an operation display portion 6, a control portion 7, and a housing 8.

The housing 8 accommodates respective constituent elements of the image forming apparatus 100. A plurality of sheet feed cassettes 11 shown in FIG. 2 are each detachably provided in the housing 8. On each of the sheet feed cassettes 11, sheets on each of which an image is to be formed are placed. As shown in FIG. 2, three sheet feed cassettes 11 (11A, 11B, and 11C) are provided in the housing 8. A sheet discharge tray 12 shown in FIG. 2 is provided on an outer side surface of the housing 8. The sheet on which an image has been formed by the image forming portion 2 is discharged onto the sheet discharge tray 12. It is noted that the number of sheet feed cassettes 11 to be provided in the housing 8 does not need to be limited to three.

As shown in FIG. 2, the first sheet conveying path 13 and the second sheet conveying path 14 that guide sheets conveyed by the sheet conveying portion 1 are provided inside the housing 8. The first sheet conveying path 13 is a sheet movement path that is provided from the vicinity of the three sheet feed cassettes 11 to the sheet discharge tray 12 via the image forming portion 2 and the heating portion 4. On the first sheet conveying path 13, the sheet is conveyed in a first conveying direction D1 (see FIG. 2) that is directed toward the sheet discharge tray 12. The second sheet conveying path 14 is used to invert a sheet in which an image has been formed on a first surface (an example of a specific surface according to the present disclosure) by the image forming portion 2. The first surface is a surface facing upward in a sheet placed on the sheet feed cassette 11. The second sheet conveying path 14 branches from a branching position P1 (see FIG. 2) that is more on a downstream side of the first conveying direction D1 than the heating portion 4 on the first sheet conveying path 13, and joins the first sheet conveying path 13 at a junction position P2 (see FIG. 2) that is more on an upstream side of the first conveying direction D1 than the image forming portion 2. On the second sheet conveying path 14, the sheet is conveyed in a second conveying direction D2 (see FIG. 2) that is directed toward the junction position P2. The second sheet conveying path 14 is an example of an inversion conveying path according to the present disclosure.

The sheet conveying portion 1 conveys the sheet inside the housing 8. As shown in FIG. 2, the sheet conveying portion 1 includes a plurality of pickup rollers 21, a plurality of first conveying roller pairs 22, and a plurality of second conveying roller pairs 23.

The plurality of pickup rollers 21 are respectively provided in correspondence with the plurality of sheet feed cassettes 11. Each of the pickup rollers 21 takes out one sheet from the corresponding sheet feed cassette 11, and feeds the sheet that has been taken out to the first sheet conveying path 13. The plurality of first conveying roller pairs 22 are provided to be aligned along the first sheet conveying path 13. Each of the first conveying roller pairs 22 conveys the sheet in the first conveying direction D1 (see FIG. 2). Of the plurality of first conveying roller pairs 22, the first conveying roller pair 22A (see FIG. 2) provided most downstream in the first conveying direction D1 rotates backward at a timing after a rear end of the conveyed sheet passes through the branching position P1, to thus feed the sheet to the second sheet conveying path 14. The plurality of second conveying roller pairs 23 are provided to be aligned along the second sheet conveying path 14. Each of the second conveying roller pairs 23 conveys the sheet in the second conveying direction D2 (see FIG. 2).

In the image forming apparatus 100, when one-side image forming processing for forming an image on one side (the first surface) of the sheet placed on the sheet feed cassette 11 is executed, the sheet is conveyed along a first conveying path that reaches the sheet discharge tray 12 without passing through the second sheet conveying path 14. The first conveying path is a path that reaches the sheet discharge tray 12 via the first sheet conveying path 13. Further, in the image forming apparatus 100, when double-sided image forming processing for forming images on both surfaces (the first surface and a second surface on a back side of the first surface) of the sheet stored in the sheet feed cassette 11 is executed, the sheet is conveyed along a second conveying path that reaches the sheet discharge tray 12 via the second sheet conveying path 14. The second conveying path is a path that passes through the first sheet conveying path 13 and the second sheet conveying path 14 and passes through the first sheet conveying path 13 again to reach the sheet discharge tray 12. The plurality of sheet feed cassettes 11 are an example of a plurality of sheet placing portions according to the present disclosure. Moreover, the second conveying path is an example of a specific conveying path according to the present disclosure.

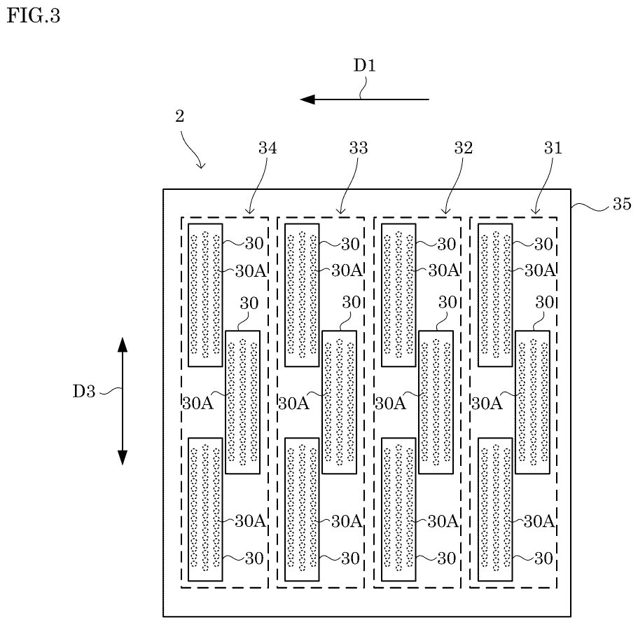

The image forming portion 2 forms an ink image on the sheet conveyed along the first conveying path or the second conveying path. As shown in FIG. 3, the image forming portion 2 includes line heads 31 to 34 respectively corresponding to the respective colors of black, cyan, magenta, and yellow and a head frame 35 that supports these. The head frame 35 is supported by the housing 8. It is noted that the number of line heads to be provided in the image forming portion 2 does not need to be limited to four.

As shown in FIG. 3, each of the line heads 31 to 34 is elongated in a width direction D3 orthogonal to the first conveying direction D1. Specifically, each of the line heads 31 to 34 has, in the width direction D3, a length corresponding to a width of a sheet of a maximum size out of the sheets that can be stored in the sheet feed cassette 11. The line heads 31 to 34 are fixed to the head frame 35 while being arranged at predetermined intervals along the first conveying direction D1.

As shown in FIG. 3, each of the line heads 31 to 34 includes a plurality of recording heads 30. Each of the recording heads 30 discharges ink toward the sheet conveyed by the sheet conveying portion 1. Specifically, a plurality of nozzles 30A (see FIG. 3) that each include an opening and are used for discharging ink are provided on an opposing surface of each of the recording heads 30 that opposes the conveyed sheet. Further, each of the recording heads 30 includes pressurization chambers (not shown) respectively corresponding to the nozzles 30A, piezoelectric elements (not shown) respectively provided in correspondence with the pressurization chambers, and individual flow paths (not shown) that are respectively in communication with the pressurization chambers. The piezoelectric element causes ink to be discharged from the nozzle 30A in accordance with an application of a predetermined driving voltage. Specifically, the piezoelectric element pressurizes the ink stored in the pressurization chamber to cause the ink to be discharged from the nozzle 30A.

As shown in FIG. 3, the line head 31 includes three recording heads 30 that are arranged in a staggered pattern along the width direction D3. Similar to the line head 31, each of the other line heads 32 to 34 also includes three recording heads 30 that are arranged in a staggered pattern along the width direction D3. Supplied to each of the line heads 31 to 34 from ink containers (not shown) is ink of a color that is the same as the color corresponding to the line head.

The cap portion 3 is provided to be movable between the cap position P3 (see FIG. 2) at which all of the nozzles 30A included in the image forming portion 2 (see FIG. 3) are capped and an evacuation position P4 (see FIG. 2) evacuated from the cap position P3. The cap position P3 is a position below the image forming portion 2. The evacuation position P4 is a position more on the downstream side of the first conveying direction D1 than the cap position P3. For example, the cap portion 3 is formed in a tray shape that includes an opposing surface opposing a lower surface of each of the line heads 31 to 34.

The heating portion 4 heats the sheet on which the ink image has been formed by the image forming portion 2 on the first sheet conveying path 13. The heating portion 4 heats the sheet on which the ink image has been formed, to thus dry the ink that has adhered onto the sheet. As shown in FIG. 2, the heating portion 4 is provided more on the downstream side of the first conveying direction D1 than the image forming portion 2 on the first sheet conveying path 13. In addition, the heating portion 4 is provided above the sheet conveyed along the first sheet conveying path 13.

For example, the heating portion 4 includes a heat source that emits infrared rays in accordance with power feeding, a reflector which reflects, on an upper side of the heat source, the infrared rays emitted from the heat source in a downward direction, and a hot-air fan that blows hot air toward the downward direction on an upper side of the reflector. The heating portion 4 blows hot air onto the sheet from the upper side of the sheet conveyed along the first sheet conveying path 13, to thus heat the sheet. It is noted that the heating portion 4 is not limited to the configuration described above and only needs to be capable of heating the sheet conveyed along the first sheet conveying path 13.

The image reading portion 5 reads an ink image formed on the sheet by the image forming portion 2 on the second sheet conveying path 14. A result of the reading by the image reading portion 5 is used for an adjustment of an image forming condition by the image forming portion 2 and the like.

As shown in FIG. 1 and FIG. 2, the image reading portion 5 includes a line sensor 41 and an AFE (Analog Front End) circuit 42.

As shown in FIG. 2, the line sensor 41 is provided on the second sheet conveying path 14. Further, the line sensor 41 is provided above the sheet conveyed along the second sheet conveying path 14. In other words, the line sensor 41 opposes the first surface of the sheet conveyed along the second sheet conveying path 14. The line sensor 41 is capable of reading, from the sheet that passes through an arrangement position of the line sensor 41 on the second sheet conveying path 14, an image corresponding to one line along a main scanning direction which is the same direction as the width direction D3 (see FIG. 3). For example, the line sensor 41 is a CIS (Contact Image Sensor). The line sensor 41 includes a plurality of image pickup devices that are arranged to be aligned in the width direction D3. Each of the image pickup devices includes a light-emitting portion and a light-receiving portion. The light-emitting portion emits light toward the sheet conveyed along the second sheet conveying path 14. The light-receiving portion is provided to be capable of receiving the light that is emitted from the light-emitting portion and reflected by the sheet conveyed along the second sheet conveying path 14, and outputs analog electric signals corresponding to the received light amount. The line sensor 41 outputs analog electric signals corresponding to the image of one line along the main scanning direction at predetermined intervals in accordance with control signals input from the control portion 7.

The AFE circuit 42 is an electronic circuit which executes predetermined processing on the analog electric signals output from the line sensor 41. Specifically, the AFE circuit 42 includes a signal conversion portion which converts the analog electric signals output from the line sensor 41 into digital electric signals (image data). In addition, the AFE circuit 42 includes an image processing portion which executes predetermined image processing such as shading correction on the image data output from the signal conversion portion. The AFE circuit 42 outputs the image data subjected to the image processing, that is output from the image processing portion, to the control portion 7.

The operation display portion 6 includes a display portion such as a liquid crystal display that displays various types of information in response to control instructions from the control portion 7 and an operation portion such as an operation key or a touch panel that is used for inputting various types of information to the control portion 7 in accordance with user operations.

The control portion 7 includes control devices such as a CPU 51, a ROM 52, and a RAM 53. The CPU 51 is a processor that executes various types of arithmetic processing. The ROM 52 is a nonvolatile storage device in which information such as control programs for causing the CPU 51 to execute various types of processing is stored in advance. The RAM 53 is a volatile or nonvolatile storage device that is used as a temporary storage memory (working area) for the various type of processing to be executed by the CPU 51. The CPU 51 executes the various control programs stored in advance in the ROM 52. Thus, the CPU 51 collectively controls the image forming apparatus 100. It is noted that the control portion 7 may be constituted of an electronic circuit such as an integrated circuit (ASIC). In addition, the control portion 7 may be provided separate from a main control portion that collectively controls the image forming apparatus 100.

Incidentally, in the image forming apparatus including the image reading portion 5, conveying an adjustment sheet on which an adjustment image for adjusting the image reading portion 5 is formed in advance along the second conveying path and adjusting the image reading portion 5 based on a result of reading the adjustment image by the image reading portion 5 is conceivable. However, when the adjustment sheet is conveyed in a state where the heating portion 4 is driven, the adjustment sheet deteriorates.

In contrast, in the image forming apparatus 100 according to the embodiment of the present disclosure, it is possible to suppress deterioration of the adjustment sheet used for the adjustment of the image reading portion 5 as will be described below.

Specifically, an adjustment program for causing the CPU 51 to function as a conveyance processing portion 61, a reading processing portion 62, and an adjustment processing portion 63 shown in FIG. 1 is stored in advance in the ROM 52 of the control portion 7. The CPU 51 executes the adjustment program to function as the respective processing portions described above. It is noted that the adjustment program is recorded onto a computer-readable recording medium such as a CD, a DVD, and a flash memory, and the adjustment program may be read from the recording medium to be stored in a nonvolatile storage device provided in the image forming apparatus 100. Alternatively, the adjustment program may be a program for causing a plurality of processors to function as the respective processing portions shown in FIG. 1. Further, some or all of the processing portions included in the control portion 7 may be constituted of an electronic circuit.

The conveyance processing portion 61 executes conveyance processing for conveying the adjustment sheet on which the predetermined adjustment image has been formed in advance without forming an ink image along the second conveying path in a state where the drive of the heating portion 4 is stopped. The adjustment sheet is a sheet in which the adjustment image is formed on the first surface. For example, the adjustment image includes a strip-like monochrome image elongated in the width direction D3.

Herein, in the conveyance processing, the adjustment sheet is conveyed in a state where the cap portion 3 is arranged at the cap position P3 (see FIG. 2). Thus, it is possible to avoid a situation where the adjustment sheet is smeared (deteriorated) by the ink that drops from the nozzles 30A.

Further, in the conveyance processing, the adjustment sheet is conveyed at a specific conveying speed slower than a conveying speed of the sheet in the image forming processing for forming the ink image on the sheet using the image forming portion 2. Thus, it is possible to suppress a damage that the adjustment sheet receives due to a contact between the adjustment sheet conveyed along the second conveying path and the members arranged on the second conveying path. For example, in the image forming processing, the sheet is conveyed at a predetermined first speed. Further, in the conveyance processing, the sheet is conveyed at a second speed that is half of the first speed. It is noted that the specific conveying speed in a case where there are a plurality of conveying speeds of the sheet in the image forming processing only needs to be set to be slower than the slowest conveying speed out of the plurality of conveying speeds in the image forming processing.

Furthermore, in the conveyance processing, the adjustment sheet is conveyed from a specific sheet feed cassette (an example of a specific sheet placing portion according to the present disclosure) whose distance to the image forming portion 2 along the second conveying path is the shortest out of the plurality of sheet feed cassettes 11. Thus, since the conveying distance of the adjustment sheet becomes short, a chance of the adjustment sheet receiving a damage during conveyance of the adjustment sheet can be reduced that much. The specific sheet feed cassette is determined in advance based on an arrangement position of each of the sheet feed cassettes 11 on the first sheet conveying path 13. The specific sheet feed cassette in the image forming apparatus 100 is the sheet feed cassette 11A (see FIG. 2).

For example, the conveyance processing portion 61 causes the operation display portion 6 to display a predetermined guide screen in accordance with a predetermined user operation made in the operation display portion 6. For example, the guide screen includes a message that guides a user to place the adjustment sheet on the sheet feed cassette 11A in an attitude in which the adjustment image faces upward, and to operate an execution key included in the guide screen after that.

Upon accepting the user operation to the execution key, the conveyance processing portion 61 stops the drive of the heating portion 4 and causes the cap portion 3 to move to the cap position P3 (see FIG. 2). Then, after the movement of the cap portion 3 to the cap position P3 and after an elapse of a predetermined standby time since the stop of the drive of the heating portion 4, the conveyance processing portion 61 executes the conveyance processing. For example, the conveyance processing is realized by executing a print job for printing a blank-sheet image (that is, no image is printed) on both surfaces of a sheet. Herein, when the cap portion 3 is arranged at the cap position P3 at the time the user operation to the execution key is accepted, the conveyance processing portion 61 does not need to move the cap portion 3. Further, when the heating portion 4 is stopped at the time the user operation to the execution key is accepted, the conveyance processing portion 61 only needs to readily execute the conveyance processing after the cap portion 3 is moved to the cap position P3.

It is noted that when the sheet feed cassette 11A is not attached to the housing 8, the conveyance processing portion 61 only needs to cause the operation display portion 6 to display a first error screen that includes a message indicating that the sheet feed cassette 11A is not attached instead of executing the conveyance processing. Further, when the size of the sheet placed on the sheet feed cassette 11A does not match the size of the adjustment sheet stored in advance in the ROM 52, the conveyance processing portion 61 only needs to cause the operation display portion 6 to display a second error screen that includes a message indicating that the adjustment sheet is not placed on the sheet feed cassette 11A instead of executing the conveyance processing. The size of the sheet placed on the sheet feed cassette 11A only needs to be determined by a known method. Moreover, when a sheet is not placed on the sheet feed cassette 11A, the conveyance processing portion 61 only needs to cause the operation display portion 6 to display the second error screen instead of executing the conveyance processing. Furthermore, when a paper jam occurs during execution of the conveyance processing, the conveyance processing portion 61 only needs to cause the operation display portion 6 to display the guide screen again after the paper jam is dealt with.

The reading processing portion 62 reads the adjustment image on the adjustment sheet conveyed by the conveyance processing using the image reading portion 5.

The adjustment processing portion 63 adjusts the image reading portion 5 based on a result of the reading by the reading processing portion 62.

For example, the adjustment processing portion 63 adjusts an emission light amount of each of the image pickup devices included in the line sensor 41 based on the result of the reading by the reading processing portion 62. Further, the adjustment processing portion 63 may adjust an execution condition of the image processing executed by the image processing portion of the AFE circuit 42 based on the result of the reading by the reading processing portion 62.

### [Adjustment Processing]

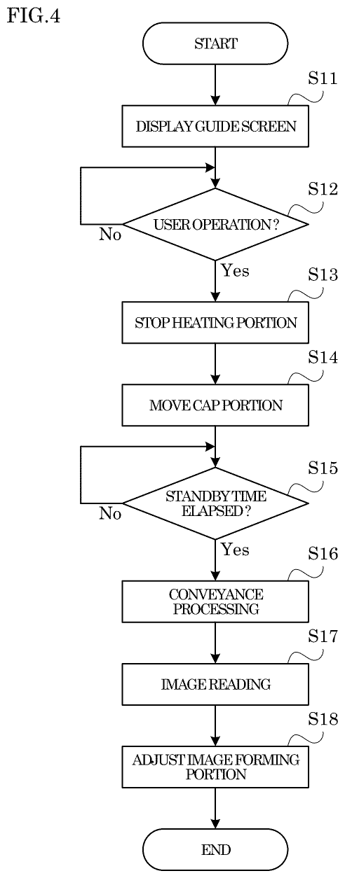

Hereinafter, with reference to FIG. 4, procedures of an adjustment method according to the present disclosure will be described along with exemplary procedures of adjustment processing executed by the control portion 7 in the image forming apparatus 100. Herein, Step S11, Step S12, . . . represent numbers of processing procedures (steps) executed by the control portion 7. It is noted that the adjustment processing is executed when a user operation that instructs execution of the adjustment processing is accepted in the operation display portion 6.

### <Step S11>

First, in Step S11, the control portion 7 causes the operation display portion 6 to display the guide screen.

### <Step S12>

In Step S12, the control portion 7 determines whether or not a user operation to the execution key included in the guide screen has been accepted.

Herein, when determining that a user operation to the execution key has been accepted (Yes in S12), the control portion 7 shifts the processing to Step S13. On the other hand, when determining that a user operation to the execution key has not been accepted (No in S12), the control portion 7 waits for the user operation to the execution key in Step S12.

### <Step S13>

In Step S13, the control portion 7 stops the drive of the heating portion 4.

### <Step S14>

In Step S14, the control portion 7 causes the cap portion 3 to move to the cap position P3 (see FIG. 2).

### <Step S15>

In Step S15, the control portion 7 determines whether or not the standby time has elapsed since the stop of the drive of the heating portion 4.

Herein, when determining that the standby time has elapsed (Yes in S15), the control portion 7 shifts the processing to Step S16. On the other hand, when determining that the standby time has not elapsed (No in S15), the control portion 7 waits for the elapse of the standby time in Step S15.

### <Step S16>

In Step S16, the control portion 7 executes the conveyance processing. The processing of Step S11 to Step S16 is an example of a conveyance step according to the present disclosure and is executed by the conveyance processing portion 61 of the control portion 7.

### <Step S17>

In Step S17, the control portion 7 reads an image on a sheet (the adjustment image on the adjustment sheet) conveyed by the conveyance processing using the image reading portion 5. The processing of Step S17 is an example of a reading step according to the present disclosure and is executed by the reading processing portion 62 of the control portion 7.

### <Step S18>

In Step S18, the control portion 7 adjusts the image reading portion 5 based on a result of the reading by the reading processing portion 62. The processing of Step S18 is an example of an adjustment step according to the present disclosure and is executed by the adjustment processing portion 63 of the control portion 7.

In this manner, in the image forming apparatus 100, the conveyance processing for conveying the adjustment sheet along the second conveying path is executed in a state where the drive of the heating portion 4 is stopped. Thus, deterioration of the adjustment sheet can be suppressed as compared to a configuration in which the adjustment sheet is conveyed in a state where the heating portion 4 is driven.

Further, in the image forming apparatus 100, the adjustment sheet is conveyed along the second conveying path. Thus, the adjustment sheet in an attitude in which the adjustment image is facing downward is discharged onto the sheet discharge tray 12. Therefore, color deterioration due to sunlight can be suppressed as compared to a configuration in which the adjustment sheet in an attitude in which the adjustment image is facing upward is discharged onto the sheet discharge tray 12.

It is noted that the conveyance processing may be processing of conveying the adjustment sheet irrespective of the arrangement position of the cap portion 3.

Further, the conveyance processing may be processing of conveying the adjustment sheet at a speed that is the same as the conveying speed of the sheet in the image forming processing.

Furthermore, the conveyance processing may be processing of conveying the adjustment sheet from an arbitrary sheet feed cassette 11.

Moreover, the image reading portion 5 may be arranged on the first sheet conveying path 13. For example, the image reading portion 5 may be arranged more on the downstream side of the first conveying direction D1 than the heating portion 4 on the first sheet conveying path 13. In this case, the conveyance processing may be processing of conveying the adjustment sheet along the first conveying path. Further, the image forming apparatus 100 does not need to include the second sheet conveying path 14.

### [Notes of Disclosure]

Hereinafter, a general outline of the disclosure extracted from the embodiment described above will be noted. It is noted that the respective configurations and processing functions described in the notes below can be sorted and arbitrarily combined as appropriate.

### <Note 1>

An image forming apparatus, including: an image forming portion which forms an ink image on a sheet conveyed along a predetermined conveying path; a heating portion which heats the sheet on which the ink image has been formed by the image forming portion on the conveying path; an image reading portion which reads the ink image formed on the sheet by the image forming portion on the conveying path; a conveyance processing portion which executes conveyance processing for conveying an adjustment sheet on which a predetermined adjustment image has been formed in advance without forming the ink image along the conveying path in a state where drive of the heating portion is stopped; a reading processing portion which reads the adjustment image on the adjustment sheet conveyed by the conveyance processing using the image reading portion; and an adjustment processing portion which adjusts the image reading portion based on a result of the reading by the reading processing portion.

### <Note 2>

The image forming apparatus according to note 1, in which the image forming portion includes nozzles which discharge ink onto the sheet, the image forming apparatus includes a cap portion which is provided to be movable between a cap position at which the nozzles are capped and an evacuation position evacuated from the cap position, and in the conveyance processing, the adjustment sheet is conveyed in a state where the cap portion is arranged at the cap position.

### <Note 3>

The image forming apparatus according to note 1 or 2, in which in the conveyance processing, the adjustment sheet is conveyed at a specific conveying speed slower than a conveying speed of the sheet in image forming processing for forming the ink image on the sheet using the image forming portion.

### <Note 4>

The image forming apparatus according to any one of notes 1 to 3, including: a plurality of sheet placing portions on each of which the sheet to be conveyed along the conveying path is placed, in which in the conveyance processing, the adjustment sheet is conveyed from a specific sheet placing portion whose distance to the image forming portion along the conveying path is shortest out of the plurality of sheet placing portions.

### <Note 5>

The image forming apparatus according to any one of notes 1 to 4, including: an inversion conveying path used for inverting the sheet in which the ink image has been formed on a specific surface by the image forming portion, in which the conveying path includes a specific conveying path that passes through the inversion conveying path, the adjustment sheet is the sheet in which the adjustment image has been formed on the specific surface, and in the conveyance processing, the adjustment sheet is conveyed along the specific conveying path.

### <Note 6>

An adjustment method executed in an image forming apparatus including an image forming portion which forms an ink image on a sheet conveyed along a predetermined conveying path, a heating portion which heats the sheet on which the ink image has been formed by the image forming portion on the conveying path, and an image reading portion which reads the ink image formed on the sheet by the image forming portion on the conveying path, the adjustment method including: a conveyance step of executing conveyance processing for conveying an adjustment sheet on which a predetermined adjustment image has been formed in advance without forming the ink image along the conveying path in a state where drive of the heating portion is stopped; a reading step of reading the adjustment image on the adjustment sheet conveyed by the conveyance processing using the image reading portion; and an adjustment step of adjusting the image reading portion based on a result of the reading in the reading step.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
an image forming portion which forms an ink image on a sheet conveyed along a predetermined conveying path;
a heating portion which heats the sheet on which the ink image has been formed by the image forming portion on the conveying path;
an image reading portion which reads the ink image formed on the sheet by the image forming portion on the conveying path;
a conveyance processing portion which executes conveyance processing for conveying an adjustment sheet on which a predetermined adjustment image has been formed in advance without forming the ink image along the conveying path in a state where drive of the heating portion is stopped;
a reading processing portion which reads the adjustment image on the adjustment sheet conveyed by the conveyance processing using the image reading portion; and
an adjustment processing portion which adjusts the image reading portion based on a result of the reading by the reading processing portion.

2. The image forming apparatus according to claim 1, wherein
the image forming portion includes nozzles which discharge ink onto the sheet,
the image forming apparatus comprises:
a cap portion which is provided to be movable between a cap position at which the nozzles are capped and an evacuation position evacuated from the cap position, and
in the conveyance processing, the adjustment sheet is conveyed in a state where the cap portion is arranged at the cap position.

3. The image forming apparatus according to claim 1, wherein
in the conveyance processing, the adjustment sheet is conveyed at a specific conveying speed slower than a conveying speed of the sheet in image forming processing for forming the ink image on the sheet using the image forming portion.

4. The image forming apparatus according to claim 1, comprising:
a plurality of sheet placing portions on each of which the sheet to be conveyed along the conveying path is placed, wherein
in the conveyance processing, the adjustment sheet is conveyed from a specific sheet placing portion whose distance to the image forming portion along the conveying path is shortest out of the plurality of sheet placing portions.

5. The image forming apparatus according to claim 1, comprising:
an inversion conveying path used for inverting the sheet in which the ink image has been formed on a specific surface by the image forming portion, wherein
the conveying path includes a specific conveying path that passes through the inversion conveying path,
the adjustment sheet is the sheet in which the adjustment image has been formed on the specific surface, and
in the conveyance processing, the adjustment sheet is conveyed along the specific conveying path.

6. An adjustment method executed in an image forming apparatus including an image forming portion which forms an ink image on a sheet conveyed along a predetermined conveying path, a heating portion which heats the sheet on which the ink image has been formed by the image forming portion on the conveying path, and an image reading portion which reads the ink image formed on the sheet by the image forming portion on the conveying path, the adjustment method comprising:
a conveyance step of executing conveyance processing for conveying an adjustment sheet on which a predetermined adjustment image has been formed in advance without forming the ink image along the conveying path in a state where drive of the heating portion is stopped;
a reading step of reading the adjustment image on the adjustment sheet conveyed by the conveyance processing using the image reading portion; and
an adjustment step of adjusting the image reading portion based on a result of the reading in the reading step.
